(19) United States
(12) Patent Application Publication
(10) Pub. No.: US 2002/0143126 A1
(43) Pub. Date: Oct. 3, 2002

(54) Ethylene resin injection molded articles

(76) Inventor: Mamoru Takahashi, Yamaguchi (JP)

Correspondence Address: Lawrence O. Miller, Sherman & Shalloway, 413 N. Washington Street, Alexandria, VA, 22314, US

(21) Appl. No.: 10/112,730

(22) Filed: Apr. 2, 2002

Related U.S. Application Data
(63) Continuation of application No. 09/646,539, filed on Sep. 19, 2000.
Application No. 09/646,539 is a 371 of international application No. PCT/JP99/00157, filed on Jan. 19, 1999.

(51) Int. Cl. C08F 210/14

(52) U.S. Cl. 526/160; 526/943; 526/348.5; 526/348.6

(57) ABSTRACT

The present invention provides an ethylene resin injection molded article having excellent environmental stress crack resistance and excellent heat resistance. The ethylene resin injection molded article is obtained by injection molding an ethylene/α-olefin copolymer having the following properties: the density is in the range of 0.880 to 0.940 g/cm³; the melt flow rate (MFR) at 190° C. under a load of 2.16 kg is in the range of 1 to 100 g/10 min; the decane-soluble component fraction (W) at room temperature and the density (d) satisfy the relation W<80×exp(−100(d-0.88))+0.1 in case of MFR≦10 g/10 min and the relation W<80×(MFR-9)^{0.28}×exp(−100(d-0.88))+0.1 in case of MFR>10 g/10 min; and the temperature (Tm (°C.)) at the maximum peak position in the endothermic curve as measured by a differential scanning calorimeter (DSC) and the density (d (g/cm³)) satisfy the relation Tm<400×d-250.

### TECHNICAL FIELD

The present invention relates to ethylene resin injection molded articles, and more particularly to injection molded articles having excellent environmental stress crack resistance.

### BACKGROUND ART

Ethylene copolymers such as ethylene/α-olefin copolymers have been molded by various molding methods and used in many fields. Such ethylene copolymers are generally prepared by the use of Ziegler catalysts.

Ethylene polymers prepared by the use of titanium catalysts selected from the Ziegler catalysts generally have wide molecular weight distribution and wide composition distribution and have excellent moldability, but their injection molded articles have problems such as sticking.

On the other hand, ethylene polymers prepared by the use of metallocene catalysts selected from the Ziegler catalysts are known to have advantages such that they generally have narrow composition distribution and their injection molded articles are almost free from sticking. It is also known that the molecular weight distribution of these copolymers is narrow.

The present inventors have made further studies of the ethylene copolymers obtained by the use of the metallocene catalysts, and as a result, they have found that injection molded articles produced from an ethylene/α-olefin copolymer obtained by the use of a specific metallocene catalyst have excellent tear properties and environmental stress crack resistance. Based on the finding, the present invention has been accomplished.

It is an object of the present invention to provide ethylene resin injection molded articles having excellent environmental stress crack resistance and heat resistance.

### DISCLOSURE OF THE INVENTION

The first ethylene resin injection molded article according to the present invention comprises an ethylene/α-olefin copolymer (A) which is a copolymer of ethylene and an α-olefin of 3 to 12 carbon atoms and has the following properties:

(i) the density is in the range of 0.880 to 0.940 g/cm³,

(ii) the melt flow rate (MFR) at 190° C. under a load of 2.16 kg is in the range of 1 to 100 g/10 min,

(iii) the decane-soluble component fraction (W (% by weight)) at room temperature and the density (d (g/cm³)) satisfy the following relation

in case of MFR≦10 g/10 min:

W<80×exp(−100(d-0.88))+0.1,

in case of MFR>10 g/10 min:

W<80×(MFR-9)^{0.26}×exp(−100(d-0.88))+0.1, and

(iv) the temperature (Tm (°C.)) at the maximum peak position in the endothermic curve as measured by a differential scanning calorimeter (DSC) and the density (d (g/cm³)) satisfy the following relation

Tm<400×d-250.

In the ethylene resin injection molded article of the invention, the ethylene/α-olefin copolymer preferably comprises a copolymer obtained by copolymerizing ethylene and an α-olefin of 3 to 12 carbon atoms in the presence of an olefin polymerization catalyst comprising:

(a) a compound of a transition metal of Group IV of the periodic table, which contains a substituted cyclopentadienyl group as a ligand, and

(b) an organoaluminum oxy-compound.

The ethylene resin injection molded article is excellent in fracture strength as well as in heat resistance and environmental stress crack resistance.

The second ethylene resin injection molded article according to the present invention preferably comprises an ethylene/α-olefin copolymer (B) which is a copolymer of ethylene and an α-olefin of 3 to 12 carbon atoms and has the following properties:

(i) the density is in the range of 0.880 to 0.940 g/cm³,

(ii) the melt flow rate (MFR) at 190° C. under a load of 2.16 kg is in the range of 1 to 100 g/10 min,

(iii) the decane-soluble component fraction (W (% by weight)) at room temperature and the density (d (g/cm³)) satisfy the following relation

in case of MFR≦10 g/10 min:

W<80×exp(−100(d-0.88))+0.1,

in case of MFR>10 g/10 min:

W<80×(MFR-9)^{0.26}×exp(−100(d-0.88)) +0.1,

(iv) the temperature (Tm (°C.)) at the maximum peak position in the endothermic curve as measured by a differential scanning calorimeter (DSC) and the density (d (g/cm³)) satisfy the following relation Tm<400×d-250,

(v) the molecular weight distribution (Mw/Mn, Mw: weight-average molecular weight, Mn: number-average molecular weight) as measured by gel permeation chromatography (GPC) is in the range of 3 to 7, and

(vi) the melt tension (MT) at 190° C. and the melt flow rate (MFR) satisfy the following relation

MT>4.0×MFR-^{0.65}.

The ethylene/α-olefin copolymer (B) is obtained by, for example, copolymerizing ethylene and an α-olefin of 3 to 12 carbon atoms in the presence of an olefin polymerization catalyst comprising:

(a) a compound of a transition metal of Group IV of the periodic table, which contains a bidentate ligand wherein two groups selected from indenyl groups and substituted indenyl groups are linked through a lower alkylene group, and

(b) an organoaluminum oxy-compound.

The ethylene resin injection molded article is excellent in tear properties as well as in heat resistance and environmental stress crack resistance.

It is preferable that when the ethylene/α-olefin copolymer (A) or (B) is subjected to a temperature rise elution test (TREF), a component that is eluted at a temperature of not lower than 100° C. is present in the copolymer and the amount of said component is not more than 10% of the whole elution amount.

### BEST MODE FOR CARRYING OUT THE INVENTION

The first ethylene resin injection molded article according to the invention is formed from an ethylene/α-olefin copolymer (A). First, the ethylene/α-olefin copolymer (A) is described.

### Ethylene/α-olefin copolymer (A)

The ethylene/α-olefin copolymer (A) for use in the invention is a random copolymer of ethylene and an α-olefin of 3 to 12 carbon atoms.

In the ethylene/α-olefin copolymer (A), constituent units derived from ethylene are present in amounts of 65 to 99% by weight, preferably 70 to 98% by weight, more preferably 75 to 96% by weight, and constituent units derived from the α-olefin of 3 to 20 carbon atoms are present in amounts of 1 to 35% by weight, preferably 2 to 30% by weight, more preferably 4 to 25% by weight.

Examples of the α-olefins of 3 to 12 carbon atoms include propylene, 1-butene, 1-pentene, 1-hexene, 4-methyl-1-pentene, 1-octene, 1-decene and 1-dodecene.

The density of the ethylene/α-olefin copolymer (A) is desired to be in the range of 0.880 to 0.940 g/cm³, preferably 0.900 to 0.940 g/cm³, more preferably 0.905 to 0.935 g/cm³.

The melt flow rate (MFR) of the ethylene/α-olefin copolymer (A), as measured at 190° C. under a load of 2.16 kg, is desired to be in the range of 0.1 to 100 g/10 min, preferably 0.3 to 50 g/10 min, more preferably 0.5 to 30 g/10 min.

The ethylene/(α-olefin copolymer (A) has the following relation between the n-decane-soluble component fraction (W (% by weight)) at 23° C. and the density (d (g/cm³)):

in case of MFR≦10 g/10 min:

W<80×exp(−100(d-0.88))+0.1, preferably W<60×exp(−100(d-0.88))+0.1, more preferably W<40×exp(−100(d-0.88))+0.1,

in case of MFR>10 g/10 min:

W<80×(MFR-9)^{0.26}×exp(−100(d-0.88))+0.1.

The ethylene/α-olefin copolymer (A) has the following relation between the temperature (Tm (°C.)) at the maximum peak position in the endothermic curve as measured by a differential scanning calorimeter (DSC) and the density (d (g/cm³)):

Tm<400×d-250,

preferably Tm<450×d-296,

more preferably Tm<500×d-343,

particularly preferably Tm<550×d-392.

It is desirable that when the ethylene/α-olefin copolymer (A) is subjected to a temperature rise elution test (TREF), a component that is eluted at a temperature of not lower than 100° C. is present in the copolymer and the amount of said component is not more than 10%, preferably 0.5 to 8%, of the whole elution amount.

The ethylene/α-olefin copolymer (A) mentioned above is favorable for injection molded articles.

The ethylene/α-olefin copolymer (A) is obtained by copolymerizing ethylene and an α-olefin of 4 to 12 carbon atoms in the presence of an olefin polymerization catalyst comprising:

(a) a compound of a transition metal of Group IV of the periodic table, which contains a substituted cyclopentadienyl group as a ligand, and

(b) an organoaluminum oxy-compound.

The olefin polymerization catalyst and the catalyst components are described below.

### (a-1) Transition Metal Compound

The compound (a-1) of a transition metal of Group IV of the periodic table, which contains a substituted cyclopentadienyl group as a ligand, (sometimes referred to as a “component (a)” hereinafter), said compound being used for the ethylene resin injection molded article of the invention, is specifically a transition metal compound represented by the following formula (I):

ML¹ₓ (I)

wherein M is a transition metal selected from Group IV of the periodic table; L¹ is a ligand coordinated to the transition metal atom, at least two ligands L¹ are each a substituted cyclopentadienyl group having 2 to 5 substituents selected from methyl and ethyl, and the ligand L¹ other than the substituted cyclopentadienyl group is a hydrocarbon group of 1 to 12 carbon atoms, an alkoxy group, an aryloxy group, a halogen atom, a trialkylsilyl group or a hydrogen atom; and x is a valence of the transition metal atom M.

In the formula (I), M is a transition metal atom selected from Group IV of the periodic table, specifically zirconium, titanium or hafnium, preferably zirconium.

L¹ is a ligand coordinated to the transition metal atom M, and at least two ligands L¹ are each a substituted cyclopentadienyl group having 2 to 5 substituents selected from methyl and ethyl. The ligands may be the same or different. The substituted cyclopentadienyl group is a substituted cyclopentadienyl group having two or more substituents, preferably a cyclopentadienyl group having 2 to 3 substituents, more preferably a di-substituted cyclopentadienyl group, particularly preferably a 1,3-substituted cyclopentadienyl group. The substituents may be the same or different.

In the formula (I), the ligand L¹ other than the substituted cyclopentadienyl group coordinated to the transition metal atom M is a hydrocarbon group of 1 to 12 carbon atoms, an alkoxy group, an aryloxy group, a halogen atom, a trialkylsilyl group or a hydrogen atom.

Examples of the transition metal compounds represented by the formula (I) include:

bis(cyclopentadienyl)zirconium dichloride,

bis(methylcyclopentadienyl)zirconium dichloride,

bis(ethylcyclopentadienyl)zirconium dichloride,

bis(n-propylcyclopentadienyl)zirconium dichloride,

bis(n-butylcyclopentadienyl)zirconium dichloride,

bis(n-hexylcyclopentadienyl)zirconium dichloride,

bis(methyl-n-propylcyclopentadienyl)zirconium dichloride,

bis(methyl-n-butylcyclopentadienyl)zirconium dichloride,

bis(dimethyl-n-butylcyclopentadienyl)zirconium dichloride,

bis(n-butylcyclopentadienyl)zirconium dibromide,

bis(n-butylcyclopentadienyl)zirconium methoxychloride,

bis(n-butylcyclopentadienyl)zirconium ethoxychloride,

bis(n-butylcyclopentadienyl)zirconium butoxychloride,

bis(n-butylcyclopentadienyl)zirconium ethoxide,

bis(n-butylcyclopentadienyl)zirconium methylchloride,

bis(n-butylcyclopentadienyl)zirconium dimethyl,

bis(n-butylcyclopentadienyl)zirconium benzylchloride,

bis(n-butylcyclopentadienyl)zirconium dibenzyl,

bis(n-butylcyclopentadienyl)zirconium phenylchloride,

bis(n-butylcyclopentadienyl)zirconium hydride chloride,

bis(dimethylcyclopentadienyl)zirconium dichloride,

bis(diethylcyclopentadienyl)zirconium dichloride,

bis(methylethylcyclopentadienyl)zirconium dichloride,

bis(dimethylethylcyclopentadienyl)zirconium dichloride,

bis(dimethylcyclopentadienyl)zirconium dibromide,

bis(dimethylcyclopentadienyl)zirconium methoxychloride,

bis(dimethylcyclopentadienyl)zirconium ethoxychloride,

bis(dimethylcyclopentadienyl)zirconium butoxychloride,

bis(dimethylcyclopentadienyl)zirconium diethoxide,

bis(dimethylcyclopentadienyl)zirconium methylchloride,

bis(dimethylcyclopentadienyl)zirconium dimethyl,

bis(dimethylcyclopentadienyl)zirconium benzylchloride,

bis(dimethylcyclopentadienyl)zirconium dibenzyl,

bis(dimethylcyclopentadienyl)zirconium phenylchloride, and

bis(dimethylcyclopentadienyl)zirconium hydride chloride.

In the above examples, the di-substituted cyclopentadienyl rings include 1,2- and 1,3-substituted cyclopentadienyl rings, and the tri-substituted cyclopentadienyl rings include 1, 2, 3- and 1, 2, 4-substituted cyclopentadienyl rings. In the present invention, transition metal compounds wherein a zirconium metal is replaced with a titanium metal or a hafnium metal in the above-mentioned zirconium compounds are also employable.

Of the above transition metal compounds represented by the formula (I), particularly preferable are:

bis(n-propylcyclopentadienyl)zirconium dichloride,

bis(n-butylcyclopentadienyl)zirconium dichloride,

bis(1-methyl-3-n-propylcyclopentadienyl)zirconium dichloride,

bis(1-methyl-3-n-butylcyclopentadienyl)zirconium dichloride,

bis(1,3-dimethylcyclopentadienyl)zirconium dichloride,

bis(1,3-diethylcyclopentadienyl)zirconium dichloride, and

bis(1-methyl-3-ethylcyclopentadienyl)zirconium dichloride.

### (b) Organoaluminum Oxy-Compound

The organoaluminum oxy-compound (b) (sometimes referred to as a “component (b)” hereinafter) for use in the invention may be benzene-soluble aluminoxane hitherto known or such a benzene-insoluble organoaluminum oxy-compound as disclosed in Japanese Patent Laid-Open Publication No. 276807/1990.

The aluminoxane can be prepared by, for example, the following processes.

(1) An organoaluminum compound such as trialkylaluminum is added to a hydrocarbon medium suspension of a compound containing adsorption water or a salt containing water of crystallization, e.g., magnesium chloride hydrate, copper sulfate hydrate, aluminum sulfate hydrate, nickel sulfate hydrate or cerous chloride hydrate, to allow the organoaluminum compound to react with the adsorption water or the water of crystallization, and the aluminoxane is recovered as a hydrocarbon solution.

(2) Water, ice or water vapor is allowed to directly act on an organoaluminum compound such as trialkylaluminum in a medium such as benzene, toluene, ethyl ether or tetrahydrofuran, and the aluminoxane is recovered as a hydrocarbon solution.

(3) An organotin oxide such as dimethyltin oxide or dibutyltin oxide is allowed to react with an organoaluminum compound such as trialkylaluminum in a medium such as decane, benzene or toluene.

The aluminoxane may contain a small amount of an organometallic component. It is possible that the solvent or the unreacted organoaluminum compound is distilled off from the recovered solution of aluminoxane and the remainder is redissolved in a solvent.

Examples of the organoaluminum compounds used for preparing the aluminoxane include:

trialkylaluminums, such as trimethylaluminum, triethylaluminum, tripropylaluminum, trlisopropylaluminum, tri-n-butylaluminum, triisobutylaluminum, tri-sec-butylaluminum, tri-tert-butylaluminum, tripentylaluminum, trihexylaluminum, trioctylaluminum and tridecylaluminum;

tricycloalkylaluminums, such as tricyclohexylaluminum and tricyclooctylaluminum;

dialkylaluminum halides, such as dimethylaluminum chloride, diethylaluminum chloride, diethylaluminum bromide and diisobutylaluminum chloride;

dialkylaluminum hydrides, such as diethylaluminum hydride and diisobutylaluminum hydride;

dialkylaluminum alkoxides, such as dimethylaluminum methoxide and diethylaluminum ethoxide; and

dialkylaluminum aryloxides, such as diethylaluminum phenoxide.

Of these, trialkylaluminums are particularly preferable.

Also employable as the organoaluminum compound is isoprenylaluminum represented by the following formula:

(i-C₄H₉)ₓAl_{y}(C₅H₁₀)_{z}

wherein x, y, z are each a positive number, and z≧2x.

The organoaluminum compounds mentioned above are used singly or in combination.

Examples of the solvents used for preparing the aluminoxane include aromatic hydrocarbons, such as benzene, toluene, xylene, cumene and cymene; aliphatic hydrocarbons, such as pentane, hexane, heptane, octane, decane, dodecane, hexadecane and octadecane; alicyclic hydrocarbons, such as cyclopentane, cyclohexane, cyclooctane and methylcyclopentane; petroleum fractions, such as gasoline, kerosine and gas oil; and halogenated products of these aromatic, aliphatic and alicyclic hydrocarbons, particularly chlorinated or brominated products thereof. Also employable are ethers such as ethyl ether and tetrahydrofuran. Of the solvents, aromatic hydrocarbons are particularly preferable.

The benzene-insoluble organoaluminum oxy-compound contains not more than 10% (in terms of Al atom), preferably not more than 5%, particularly preferably not more than 2%, of an Al component that is soluble in benzene at 60° C. , and is insoluble or sparingly soluble in benzene.

The solubility of the organoaluminum oxy-compound in benzene can be determined in the following manner. The organoaluminum oxy-compound in an amount corresponding to 100 mg·atom of Al is suspended in 100 ml of benzene, and they are mixed at 60° C. for 6 hours with stirring. Then, the mixture is subjected to hot filtration at 60° C. using a jacketed G-5 glass filter, and the solid separated on the filter is washed four times with 50 ml of benzene at 60° C. to obtain filtrates. The amount (×mmol) of Al atom present in all of the filtrates is measured to determine the solubility (x %).

The transition metal compound (a) and the organoaluminum oxy-compound (b) are generally used in a supported state on a carrier (c).

### Carrier (c)

The carrier (c) for use in the invention is an inorganic or organic compound of granular or particulate solid having a particle diameter of 10 to 300 μm, preferably 20 to 200 μm. The inorganic carrier is preferably a porous oxide, and examples thereof include SiO₂, Al₂O₃, MgO, ZrO₂, TiO₂, B₂O₃, CaO, ZnO, BaO, ThO₂, and mixtures thereof such as SiO₂-MgO, SiO₂-Al₂O₃, SiO₂-TiO₂, SiO₂-V₂O₅, SiO₂-Cr₂O₃ and SiO₂-TiO₂-MgO. Of these, preferable are oxides containing at least one component selected from the group consisting of SiO₂ and Al₂O₃ as their major component.

The inorganic oxides may contain small amounts of carbonate, sulfate, nitrate and oxide components, such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O and Li₂O.

Although the carriers (c) differ in the properties depending upon the type and the preparation process, the carrier preferably used in the invention is desired to have a specific surface area of 50 to 1000 m²/g, preferably 100 to 700 m²/g, and a pore volume of 0.3 to 2.5 cm²/g. If desired, the carrier is calcined at a temperature of 100 to 1000° C. , preferably 150 to 700° C., prior to use.

Also employable as the carrier in the invention is an organic compound of granular or particulate solid having a particle diameter of 10 to 300 μm. Examples of such organic compounds include (co)polymers produced using an α-olefin of 2 to 14 carbon atoms such as ethylene, propylene, 1-butene or 4-methyl-1-pentene as a main component, and (co)polymers produced using vinylcyclohexane or styrene as a main component.

The olefin polymerization catalyst used for preparing the ethylene/α-olefin copolymer for use in the invention is formed from the component (a), the component (b) and the carrier (c), but an organoaluminum compound (d) may also be used, if necessary.

### (d) Organoaluminum Compound

The organoaluminum compound (d) (sometimes referred to as a “component (d)” hereinafter) that is optionally used is, for example, an organoaluminum compound represented by the following formula (III):

R¹ₙAlX₃₋ₙ (III)

wherein R¹ is a hydrocarbon group of 1 to 12 carbon atoms, X is a halogen atom or a hydrogen atom, and n is 1 to 3.

In the formula (III), R¹ is a hydrocarbon group of 1 to 12 carbon atoms, e.g., an alkyl group, a cycloalkyl group or an aryl group. Examples of such groups include methyl, ethyl, n-propyl, isopropyl, isobutyl, pentyl, hexyl, octyl, cyclopentyl, cyclohexyl, phenyl and tolyl.

Examples of such organoaluminum compounds include:

trialkylaluminums, such as trimethylaluminum, triethylaluminum, triisopropylaluminum,

triisobutylaluminum, trioctylaluminum and tri-2-ethylhexylaluminum;

alkenylaluminums, such as isoprenylaluminum;

dialkylaluminum halides, such as dimethylaluminum chloride, diethylaluminum chloride, diisopropylaluminum chloride, diisobutylaluminum chloride and dimethylaluminum bromide;

alkylaluminum sesquihalides, such as methylaluminum sesquichloride, ethylaluminum sesquichloride, isopropylaluminum sesquichloride, butylaluminum sesquichloride and ethylaluminum sesquibromide;

alkylaluminum dihalides, such as methylaluminum dichloride, ethylaluminum dichloride, isopropylaluminum dichloride and ethylaluminum dibromide; and

alkylaluminum hydrides, such as diethylaluminum hydride and diisobutylaluminum hydride.

Also employable as the organoaluminum compound (d) is a compound represented by the following formula (IV):

R¹ₙAlY₃₋ₙ (IV)

wherein R¹ is the same hydrocarbon as indicated by R¹ in the formula (III); Y is —OR² group, —OSiR³₃ group, —OAlR⁴₂ group, —NR⁵₂ group, —SiR⁶₃ group or —N(R⁷)AlR⁸₂ group; n is 1 to 2; R², R³, R⁴ and R⁸ are each methyl, ethyl, isopropyl, isobutyl, cyclohexyl, phenyl or the like; R⁵ is hydrogen, methyl, ethyl, isopropyl, phenyl, trimethylsilyl or the like; and R⁶ and R⁷ are each methyl, ethyl or the like.

Examples of such organoaluminum compounds include:

(1) compounds represented by R¹ₙAl(OR²)₃₋ₙ, such as dimethylaluminum methoxide, diethylaluminum ethoxide and diisobutylaluminum methoxide;

(2) compounds represented by R¹ₙAl(OSiR³₃)₃₋ₙ, such as Et₂Al(OSiMe₃), (iso-Bu)₂Al(OSiMe₃) and (iso-Bu)₂Al(OSiEt₃);

(3) compounds represented by R¹ₙAl(OAlR⁴₂)₃₋ₙ, such as Et₂AlOAlEt₂ and (iso-Bu)₂AlOAl(iso-Bu)₂;

(4) compounds represented by R¹ₙAl(NR⁵₂)₃₋ₙ, such as Me₂AlNEt₂, Et₂AlNHMe, Me₂AlNHEt, Et₂AlN(SiMe₃)₂ and (iso-Bu)₂AlN(SiMe₃)₂;

(5) compounds represented by R¹ₙAl(SiR⁶₃)₃₋ₙ, such as (iso-Bu)₂AlSiMe₃; and

(6) compounds represented by R¹ₙAl(N(R⁷)AlR⁸₂)₃₋ₙ, such as Et₂AlN(Me)AlEt₂ and (iso-Bu)₂AlN(Et)Al(iso-Bu)₂.

Of the organoaluminum compounds represented by the formulas (III) and (IV), preferable are compounds represented by the formulas R¹₃Al, R¹ₙAl(OR²)₃₋ₙ and R¹ₙAl(OAlR⁴₂)₃₋ₙ, and particularly preferable are compounds of said formulas wherein R¹ is an isoalkyl group and n is 2.

### Preparation of Catalyst Component

In the preparation of the ethylene/α-olefin copolymer for use in the invention, a catalyst prepared by contacting the component (a), the component (b), the carrier (c), and if necessary, the component (d) with one another is employed. Although the components may be contacted in any order, it is preferable to contact the carrier (c) with the component (a), then with the component (b), and then if necessary, with the component (d).

The contact of the components can be carried out in an inert hydrocarbon solvent. Examples of the inert hydrocarbon media used for preparing the catalyst include aliphatic hydrocarbons, such as propane, butane, pentane, hexane, heptane, octane, decane, dodecane and kerosine; alicyclic hydrocarbons, such as cyclopentane, cyclohexane and methylcyclopentane; aromatic hydrocarbons, such as benzene, toluene and xylene; halogenated hydrocarbons, such as ethylene chloride, chlorobenzene and dichloromethane; and mixtures of these hydrocarbons.

In the contact of the component (a), the component (b), the carrier (c) and the component (d) optionally used, the component (a) is used in an amount of usually 5×10⁻⁶ to 5×10⁴ mol, preferably 10⁻⁵ to 2×10⁻⁴ mol, based on 1 g of the carrier (c), and the concentration of the component (a) is in the range of about 10⁻⁴ to 2×10 ⁻² mol/liter, preferably 2×10⁻⁴ to 10⁻² mol/liter. The atomic ratio (Al/transition metal) of aluminum in the component (b) to the transition metal in the component (a) is in the range of usually 10 to 500, preferably 20 to 200. The atomic ratio ((Al-d)/(Al-b)) of an aluminum atom (Al-d) in the component (d) optionally used to an aluminum atom (Al-b) in the component (b) is in the range of usually 0.02 to 3, preferably 0.05 to 1.5. In the contact of the component (a), the component (b), the carrier (c) and the component (d) optionally used, the mixing temperature is in the range of usually −50 to 150° C., preferably −20 to 120° C., and the contact time is in the range of 1 minute to 50 hours, preferably 10 minutes to 25 hours.

In the olefin polymerization catalyst obtained as above, the transition metal atom derived from the component (a) is desirably supported in an amount of 5×10⁻⁶ to 5×10⁻⁴ g·atom, preferably 10⁻⁵ to 2×10⁻⁴ g·atom, based on 1 g of the carrier (c), and the aluminum atom derived from the component (b) and the component (d) is desirably supported in an amount of 10⁻³ to 5×10⁻² g·atom, preferably 2×10⁻³ to 2×10⁻² g·atom, based on 1 g of the carrier (c).

The catalyst used for preparing the ethylene/α-olefin copolymer may be a prepolymerized catalyst obtained by prepolymerizing an olefin in the presence of the component (a), the component (b), the carrier (c) and the component (d) optionally used. The prepolymerization can be carried out by introducing an olefin into an inert hydrocarbon solvent in the presence of the component (a), the component (b), the carrier (c) and the component (d) optionally used.

Examples of the olefins used in the prepolymerization include ethylene and α-olefins of 3 to 20 carbon atoms, such as propylene, 1-butene, 1-pentene, 4-methyl-1-pentene, 1-hexene, 1-octene, 1-decene, 1-dodecene and 1-tetradecene. Of these, particularly preferable is ethylene or a combination of ethylene and an α-olefin, that is used in the polymerization.

In the prepolymerization, the component (a) is used in an amount of usually 10⁻⁶ to 2×10⁻² mol/liter, preferably 5×10⁻⁵ to 10⁻² mol/liter, and the component (a) is used in an amount of usually 5×10⁻⁶ to 5×10⁻⁴ mol, preferably 10⁻⁵ to 2×10⁻⁴ mol, based on 1 g of the carrier (c). The atomic ratio (Al/transition metal) of aluminum in the component (b) to the transition metal in the component (a) is in the range of usually 10 to 500, preferably 20 to 200. The atomic ratio ((Al-d)/(Al-b)) of an aluminum atom (Al-d) in the component (d) optionally used to an aluminum atom (Al-b) in the component (b) is in the range of usually 0.02 to 3, preferably 0.05 to 1.5. The prepolymerization temperature is in the range of −20 to 80° C., preferably 0 to 60° C., and the prepolymerization time is in the range of 0.5 to 100 hours, preferably about 1 to 50 hours.

The prepolymerized catalyst is prepared by, for example, the following process. The carrier (c) is suspended in an inert hydrocarbon to give a suspension. To the suspension, the organoaluminum oxy-compound (component (b)) is added, and they are reacted for a given period of time. Then, the supernatant liquid is removed, and the resulting solid component is resuspended in an inert hydrocarbon. To the system, the transition metal compound (component (a)) is added, and the reaction is conducted for a given period of time. Then, the supernatant liquid is removed to obtain a solid catalyst component. Subsequently, to an inert hydrocarbon containing the organoaluminum compound (component (d)), the above-obtained solid catalyst component is added and an olefin is further introduced, whereby a prepolymerized catalyst is obtained. It is desirable that the amount of an olefin polymer produced in the prepolymerization is in the range of 0.1 to 500 g, preferably 0.2 to 300 g, more preferably 0.5 to 200 g, based on 1 g of the carrier (c). In the prepolymerized catalyst, the component (a) is desirably supported in an amount of about 5×10⁻⁶ to 5×10⁻⁴ g·atom, preferably 10⁻⁵ to 2×10⁻⁴ g·atom, in terms of the transition metal atom, based on 1 g of the carrier (c), and the aluminum atom (Al) derived from the component (b) and the component (d) is desirably supported in such an amount that the molar ratio (Al/M) of the aluminum atom (Al) to the transition metal atom (M) derived from the component (a) becomes 5 to 200, preferably 10 to 150.

The prepolymerization can be carried out by any of batchwise and continuous processes, and can be carried out under reduced pressure, at atmospheric pressure or under pressure. In the prepolymerization, it is desirable to produce a prepolymer having an intrinsic viscosity (η), as measured in decalin at 135° C., of 0.2 to 7 dl/g, preferably 0.5 to 5 dl/g, by allowing hydrogen to be present in the system.

The ethylene/α-olefin copolymer for use in the invention is obtained by copolymerizing ethylene and an α-olefin of 3 to 20 carbon atoms in the presence of the olefin polymerization catalyst or the prepolymerized catalyst described above.

In the present invention, the copolymerization of ethylene and an α-olefin is carried out in a gas phase or a liquid phase of slurry. In the slurry polymerization, an inert hydrocarbon may be used as a solvent, or the olefin itself may be used as a solvent.

Examples of the inert hydrocarbon solvents used in the slurry polymerization include aliphatic hydrocarbons, such as butane, isobutane, pentane, hexane, octane, decane, dodecane, hexadecane and octadecane; alicyclic hydrocarbons, such as cyclopentane, methylcyclopentane, cyclohexane and cyclooctane; aromatic hydrocarbons, such as benzene, toluene and xylene; and petroleum fractions, such as gasoline, kerosine and gas oil. Of the inert hydrocarbon media, preferable are aliphatic hydrocarbons, alicyclic hydrocarbons and petroleum fractions.

When the copolymerization is carried out as slurry polymerization or gas phase polymerization, the olefin polymerization catalyst or the prepolymerized catalyst is desirably used in an amount of usually 10⁻⁸ to 10⁻³ g·atom/liter, preferably 10⁻⁷ to 10⁻⁴ g·atom/liter, in terms of a concentration of the transition metal atom in the polymerization reaction system.

In the polymerization, an-organoaluminum oxy-compound similar to the component (b) and/or the organoaluminum compound (d) may be added. In this case, the atomic ratio (Al/M) of an aluminum atom (Al) derived from the organoaluminum oxy-compound and the organoaluminum compound to the transition metal atom (M) derived from the transition metal compound (a) is in the range of 5 to 300, preferably 10 to 200, more preferably 15 to 150.

When the slurry polymerization is conducted, the polymerization temperature is in the range of usually −50 to 100° C., preferably 0 to 90° C. When the gas phase polymerization is conducted, the polymerization temperature is in the range of usually 0 to 120° C., preferably 20 to 100° C.

The polymerization pressure is in the range of usually atmospheric pressure to 100 kg/cm², preferably 2 to 50 kg/cm². The polymerization can be carried out by any of batchwise, semi-continuous and continuous processes.

It is possible to conduct polymerization in two or more stages under different reaction conditions.

To the ethylene/α-olefin copolymer for use in the invention, additives, such as weathering stabilizer, heat stabilizer, antistatic agent, anti-slip agent, anti-blocking agent, anti-fogging agent, lubricant, pigment, dye, nucleating agent, plasticizer, anti-aging agent, hydrochloric acid absorbent and antioxidant, may be optionally added in amounts not detrimental to the object of the present invention. Further, other polymer compounds can be blended in small amounts without departing from the spirit of the present invention.

Next, the second ethylene/α-olefin copolymer (B) according to the invention is described.

### Ethylene/α-Olefin Copolymer (B)

The ethylene/α-olefin copolymer (B) for use in the invention is a random copolymer of ethylene and an (α-olefin of 3 to 12 carbon atoms.

In the ethylene/α-olefin copolymer, constituent units derived from ethylene are present in amounts of 65 to 99% by weight, preferably 70 to 98% by weight, more preferably 75 to 96% by weight, and constituent units derived from the α-olefin of 3 to 20 carbon atoms are present in amounts of 1 to 35% by weight, preferably 2 to 30% by weight, more preferably 4 to 25% by weight.

Examples of the α-olefins of 3 to 12 carbon atoms include propylene, 1-butene, 1-pentene, 1-hexene, 4-methyl-1-pentene, 1-octene, 1-decene and 1-dodecene.

The density of the ethylene/α-olefin copolymer (B) is desired to be in the range of 0.880 to 0.940 g/cm³, preferably 0.900 to 0.940 g/cm³, more preferably 0.905 to 0.935 g/cm³.

The melt flow rate (MFR) of the ethylene/α-olefin copolymer (B), as measured at 190° C. under a load of 2.16 kg, is desired to be in the range of 0.1 to 100 g/10 min, preferably 0.3 to 50 g/10 min, more preferably 1 to 10 g/10 min.

The ethylene/α-olefin copolymer (B) has the following relation between the n-decane-soluble component fraction (W (% by weight)) at 23° C. and the density (d (g/cm³)):

in case of MFR≦10 g/10 min:

W<80×exp(−100(d-0.88))+0.1, preferably W<60×exp(−60×(−100(d-0.88))+0.1, more preferably W<40×exp(−100(d-0.88))+0.1,

in case of MFR>10 g/10 min:

W<80×(MFR-9)^{0.26}×exp(−100(d-0.88))+0.1.

The ethylene/α-olefin copolymer (B) has the following relation between the temperature (Tm (°C.)) at the maximum peak position in the endothermic curve as measured by a differential scanning calorimeter (DSC) and the density (d (g/cm³)):

Tm<400×d-250,

preferably Tm<450×d-296,

more preferably Tm<500×d-343,

particularly preferably Tm<550×d-392.

It is desirable that when the ethylene/α-olefin copolymer (B) is subjected to a temperature rise elution test (TREF), a component that is eluted at a temperature of not lower than 100° C. is present in the copolymer and the amount of said component is not more than 10%, preferably 0.5 to 8%, of the whole elution amount.

The molecular weight distribution (Mw/Mn, Mw: weight-average molecular weight, Mn: number-average molecular weight) of the ethylene/α-olefin copolymer (B), as measured by gel permeation chromatography (GPC), is desired to be in the range of 3 to 7, preferably 4 to 6.

The ethylene/α-olefin copolymer (B) has the following relation between the melt tension (MT (g)) at 190° C. and the melt flow rate (MFR (g/10 min)):

MT>4.0×MFR-0.65,

preferably MT>5.0×MFR-0.65.

The ethylene/α-olefin copolymer (B) mentioned above is favorable for injection molded articles.

The ethylene/α-olefin copolymer can be prepared by, for example, copolymerizing ethylene and an α-olefin of 4 to 12 carbon atoms in the presence of an olefin polymerization catalyst comprising:

(a) a compound of a transition metal of Group IV of the periodic table, which contains a bidentate ligand wherein two groups selected from indenyl groups and substituted indenyl groups are linked through a lower alkylene group, and

(b) an organoaluminum oxy-compound.

The olefin polymerization catalyst and the catalyst components are described below.

### Transition Metal Compound (a-2)

For the polyethylene injection molded article of the invention, (a-2) a compound of a transition metal of Group IV of the periodic table, which contains a bidentate ligand wherein two groups selected from indenyl groups and substituted indenyl groups are linked through a lower alkylene group, (sometimes referred to as a “component (a-2)” hereinafter) can be employed.

The component (a-2) is specifically a transition metal compound represented by the following formula (II):

MKL²ₓ₋₂ (II)

wherein M is a transition metal atom selected from Group IV of the periodic table; K and L² are each a ligand coordinated to the transition metal atom; the ligand K is a bidentate ligand wherein the same or different groups selected from indenyl groups, substituted indenyl groups and their partially hydrogenated products are linked through a lower alkylene group; the ligand L² is a hydrocarbon group of 1 to 12 carbon atoms, an alkoxy group, an aryloxy group, a halogen atom, a trialkylsilyl group or a hydrogen atom; and x is a valence of the transition metal atom M.

In the formula (II), M is a transition metal atom selected from Group IV of the periodic table, specifically zirconium, titanium or hafnium, preferably zirconium.

K is a ligand coordinated to the transition metal atom, and is a bidentate ligand wherein the same or different groups selected from indenyl groups, substituted indenyl groups and partially hydrogenated products of indenyl groups and substituted indenyl groups are linked through a lower alkylene group.

Examples of such ligands include an ethylenebisindenyl group, an ethylenebis(4, 5, 6, 7-tetrahydro-1-indenyl) group, an ethylenebis(4-methyl-1-indenyl) group, an ethylenebis(5-methyl-1-indenyl) group, an ethylenebis(6-methyl-1-indenyl) group and an ethylenebis(7-methyl-1-indenyl) group.

L² is a hydrocarbon group of 1 to 12 carbon atoms, an alkoxy group, an aryloxy group, a halogen atom, a trialkylsilyl group or a hydrogen atom.

Examples of the hydrocarbon groups of 1 to 12 carbon atoms include alkyl groups, cycloalkyl groups, aryl groups and aralkyl groups. More specifically, there can be mentioned alkyl groups, such as methyl, ethyl, n-propyl, isopropyl, n-butyl, isobutyl, sec-butyl, t-butyl, pentyl, hexyl, octyl, 2-ethylhexyl and decyl; cycloalkyl groups, such as cyclopentyl and cyclohexyl; aryl groups, such as phenyl and tolyl; and aralkyl groups, such as benzyl and neophyl.

Examples of the alkoxy groups include methoxy, ethoxy, n-propoxy, isopropoxy, n-butoxy, isobutoxy, sec-butoxy, t-butoxy, pentoxy, hexoxy and octoxy.

An example of the aryloxy group is phenoxy.

The halogen atom is fluorine, chlorine, bromine or iodine.

Examples of the trialkylsilyl groups include trimethylsilyl, triethylsilyl and triphenylsilyl.

Examples of the transition metal compounds represented by the formula (II) include:

ethylenebis(indenyl)zirconium dichloride,

ethylenebis(4-methyl-1-indenyl)zirconium dichloride,

ethylenebis(4, 5, 6, 7-tetrahydro-1-indenyl)zirconium dichloride,

ethylenebis(5-methyl-1-indenyl)zirconium dichloride,

ethylenebis(6-methyl-1-indenyl)zirconium dichloride,

ethylenebis(7-methyl-1-indenyl)zirconium dichloride,

ethylenebis(4-methyl-1-indenyl)zirconium dibromide,

ethylenebis(4-methyl-1-indenyl)zirconium methoxychloride,

ethylenebis(4-methyl-1-indenyl)zirconium ethoxychloride,

ethylenebis(4-methyl-1-indenyl)zirconium butoxychloride,

ethylenebis(4-methyl-1-indenyl)zirconium methoxide,

ethylenebis(4-methyl-1-indenyl)zirconium methylchloride,

ethylenebis(4-methyl-1-indenyl)zirconium dimethyl,

ethylenebis(4-methyl-1-indenyl)zirconium benzylchloride,

ethylenebis(4-methyl-1-indenyl)zirconium dibenzyl,

ethylenebis(4-methyl-1-indenyl)zirconium phenylchloride, and

ethylenebis(4-methyl-1-indenyl)zirconium hydride chloride.

In the present invention, transition metal compounds wherein a zirconium metal is replaced with a titanium metal or a hafnium metal in the above-mentioned zirconium compounds are also employable.

Of the above transition metal compounds represented by the formula (II), particularly preferable are:

ethylenebis(indenyl)zirconium dichloride,

ethylenebis(4-methyl-1-indenyl)zirconium dichloride, and

ethylenebis(4, 5, 6, 7-tetrahydro-1-indenyl)zirconium dichloride.

The components other than the transition metal compound (a-2), i.e., the organoaluminum oxy-compound (b), the carrier (c) and the organoaluminum compound (d), the process for preparing the catalyst, and the polymerization process, etc. are identical with those previously described with respect to the Group IV transition metal compound (a-1) containing a specific substituted cyclopentadienyl group as a ligand.

### Injection Molded Article

The ethylene resin injection molded article according to the invention is obtained by injection molding the above-described ethylene/α-olefin copolymer.

As the injection molding method, any of injection molding methods usually carried out can be employed without specific limitation.

### EFFECT OF THE INVENTION

According to the present invention, an injection molded article excellent in tear properties, heat resistance and environmental stress crack resistance can be provided.

### EXAMPLE

The present invention is further described with reference to the following examples, but it should be construed that the invention is in no way limited to those examples.

Definitions of property values, measurements of properties and a molding method used in the present invention are described below.

(1) Granulation of ethylene/α-olefin copolymer

To 100 parts by weight of an ethylene/α-olefin copolymer powder obtained by gas phase polymerization, 0.05 part by weight of tri(2,4-di-t-butylphenyl)phosphate as a secondary antioxidant, 0.1% by weight of n-octadecyl-3-(4′-hydroxy-3′, 5′-di-t-butylphenyl)propionate as a heat stabilizer and 0.05 part by weight of calcium stearate as a hydrochloric acid absorbent were added. Then, the mixture was melt extruded by a conical tapered twin-screw extruder manufactured by Harque Co. at a preset temperature of 180° C. to prepare granulation pellets.

(2) Density

Strands obtained in the measurement of melt flow rate at 190° C. under a load of 2.16 kg were heat treated at 120° C. for 1 hour and then slowly cooled to room temperature over a period of 1 hour, followed by measuring the density by a density gradient tube.

(3) Composition of copolymer

Composition of a copolymer was determined by ¹³C-NMR. That is, in a sample tube having a diameter of 10 mm, a copolymer powder of about 200 mg was homogeneously dissolved in 1 ml of hexachlorobutadiene to give a sample, and a ¹³C-NMR spectrum of the sample was measured under the conditions of a measuring temperature of 120° C., a measuring frequency of 25.05 MHz, a spectral width of 1500 Hz, a pulse repetition time of 4.2 sec and a pulse width of 6 μsec, to determine composition of the copolymer.

(4) Melt flow rate (MFR)

Using granulation pellets of a copolymer, the melt flow rate was measured in accordance with ASTM D1238-65T under the conditions of a temperature of 190° C. and a load of 2.16 kg.

(5) Peak temperature (Tm) measured by DSC

The temperature (Tm) at the peak position in the endothermic curve was determined in the following manner using an apparatus of DSC-7 Model manufactured by Perkin Elmer Co. A sample of about 5 mg was placed in an aluminum pan, heated up to 200° C. at a rate of 10° C. /min, held at 200° C. for 5 minutes, cooled to room temperature at a rate of 10° C. /min and then heated at a rate of 10° C./min to give an endothermic curve, from which the temperature at the peak position was found.

(6) n-Decane-soluble component fraction (W)

The amount of a n-decane-soluble component in a copolymer was measured by a method comprising adding about 3 g of the copolymer to 450 ml of n-decane, dissolving the copolymer at 145° C., cooling the resulting solution to 23° C., removing a n-decane-insoluble component by filtration and recovering a n-decane-soluble component from the filtrate.

The n-decane-soluble component fraction is defined as follows.

w (%)=Weight of n-decane-soluble component/(Weight of n-decane-insoluble and soluble components)×100

A smaller value of the soluble component fraction means a narrower composition distribution.

(7) Elastic modulus

A dumbbell having a size based on JIS K6718 was punched from a film to give a specimen. A dumbbell punched in parallel with the take-off direction of the film is a MD dumbbell, and a dumbbell punched at right angles to the take-off direction of the film is a TD dumbbell.

The specimen was set up in air chucks of an Instron type universal tester and subjected to a tensile test under the conditions of a chuck distance of 86 mm and a pulling rate of 200 mm/min. The slope of the initial stress to the displacement is taken as an elastic modulus.

(8) Temperature rise elution properties (TREF)

A sample solution was introduced into a column at 140° C., then cooled to 25° C. at a cooling rate of 10° C./hr and heated at a heating rate of 15° C./hr to detect, on the online system, components having been continuously eluted at a constant flow rate of 1.0 ml.

This test was carried out using a column of 2.14 cm (diameter)×15 cm, glass beads having a diameter of 100 μm as filler and orthodichlorobenzene as a solvent under the test conditions of a sample concentration of 200 mg/40 ml-orthodichlorobenzene and a pour of 7.5 ml.

(9) Environmental stress crack resistance (ESCR)

The stress cracking time was measured in accordance with ASTM D1693. The time taken for 50% cracking is expressed by F₅₀.

Surface active agent: Antalox (concentration=100%)

Test temperature: 50° C.

(10) Tensile test

A tensile test was carried out in accordance with ASTM D658 to measure strength at break and elongation at break.

(11) Izod impact test (IZ)

An Izod impact test was carried out in accordance with ASTM D256 to measure Izod impact strength.

Temperature: 23° C.

Specimen: 12.7 (width)×6.4 (length)×64 (length) mm

Notch: mechanically made

### Preparation Example 1

### Preparation of ethylene/α-olefin copolymer (A-1)

### Preparation of catalyst

In 154 liters of toluene, 10 kg of silica having been dried at 250° C. for 10 hours was suspended, and the suspension was cooled to 0° C. Thereafter, 57.5 liters of a toluene solution of methylaluminoxane (Al=1.33 mol/l) was dropwise added over a period of 1 hour. During the addition, the temperature of the system was maintained at 0° C. The reaction was successively conducted at 0° C. for 30 minutes. Then, the temperature of the system was raised up to 95° C. over a period of 1.5 hours, and at that temperature, the reaction was conducted for 20 hours. Thereafter, the temperature of the system was lowered to 60° C., and the supernatant liquid was removed by decantation. The resulting solid component was washed twice with toluene and then resuspended in 100 liters of toluene. To the system, 16.8 liters of a toluene solution of bis(l-methyl-3-n-butylcyclopentadienyl)zirconium dichloride (Zr=27.0 mmol/l) was dropwise added at 80° C. over a period of 30 minutes, and the reaction was further conducted at 80° C. for 2 hours. Then, the supernatant liquid was removed, and the remainder was washed twice with hexane to obtain a solid catalyst containing zirconium in an amount of 3.5 mg per gram of the solid catalyst.

Preparation of prepolymerized catalyst

To 87 liters of hexane containing 2.5 mol of triisobutylaluminum, 870 g of the solid catalyst obtained above and 260 g of 1-hexene were added, and prepolymerization of ethylene was conducted at 35° C. for 5 hours to obtain a prepolymerized catalyst wherein polyethylene had been produced by prepolymerization in an amount of 10 g per gram of the solid catalyst.

### Polymerization

In a continuous type fluidized bed gas phase polymerization apparatus, copolymerization of ethylene and 1-hexene was conducted at a polymerization temperature of 80° C. under a total pressure of 20 kg/cm²-G. To the system were continuously fed the above-obtained prepolymerized catalyst at a rate of 0.33 mmol/hr in terms of a zirconium atom and triisobutylaluminum at a rate of 10 mmol/hr. During the polymerization, ethylene, 1-hexene, hydrogen and nitrogen were continuously fed to maintain the gas composition constant (gas composition: 1-hexene/ethylene=0.02, hydrogen/ethylene=4.6×10⁻⁴, ethylene concentration=70%)

The yield of the resulting ethylene/α-olefin copolymer (A-1) was 60 kg/hr, the density of the copolymer was 0.919 g/cm³, MFR thereof was 18.5 g/10 min, the temperature (Tm) at the maximum peak position in the endothermic curve as measured by DSC was 114.5° C., and the amount of the decane-soluble component at room temperature was 0.58% by weight.

### Example 1

The ethylene/α-olefin copolymer (A-1) obtained in Preparation Example 1 was pelletized by an extruder and injection molded under the conditions of a resin temperature of 200° C. and a mold temperature of 40° C. to prepare an ASTM specimen. Then, the properties of the specimen were measured.

The results are set forth in Table 2.

### Preparation Example 2

### Preparation of catalyst

A polymerization catalyst was obtained in the same manner as in the preparation of catalyst component in

Preparation Example 1, except that 3.2 liters of a toluene solution of bis(1,3-dimethylcyclopentadienyl)zirconium dichloride (Zr: 28.1 mmol/l) and 10.7 liters of a toluene solution of bis(1,3-n-butylmethylcyclopentadienyl)zirconium dichloride (Zr: 34.0 mmol/l) were used instead of 16.8 liters of the toluene solution of bis(1,3-n-butylmethylcyclopentadienyl)zirconium dichloride.

### Polymerization

An ethylene/α-olefin copolymer (A-2) was obtained in the same manner as in Preparation Example 1, except that the above-obtained polymerization catalyst was used so as to obtain a copolymer having a density and MFR shown in Table 1.

### Example-2

The ethylene/α-olefin copolymer (A-2) obtained in Preparation Example 2 was injection molded in the same manner as in Example 1 to prepare a specimen for property measurement, and the properties of the specimen were measured.

The results are set forth in Table 2.

### Preparation Examples 3 and 4

Ethylene/α-olefin copolymers (A-3) and (A-4) were each obtained in the same manner as in Preparation Example 1, except that the reaction conditions were controlled so as to obtain a copolymer having a density and MFR shown in Table 1.

### Examples 3 and 4

The ethylene/α-olefin copolymers obtained in Preparation Examples 3 and 4 were each injection molded in the same manner as in Example 1 to prepare a specimen for property measurement, and the properties of the specimen were measured.

The results are set forth in Table 2.

### Preparation Example 5

Preparation of catalyst

A polymerization catalyst was obtained in the same manner as in the preparation of catalyst component in Preparation Example 1, except that 16.1 liters of a toluene solution of bis(1,3-dimethylcyclopentadienyl)zirconium dichloride (Zr: 28.1 mmol/l) was used instead of the toluene solution of bis(1,3-n-butylmethylcyclopentadienyl)zirconium dichloride.

### Polymerization

An ethylene/α-olefin copolymer (A-5) was obtained in the same manner as in Preparation Example 1, except that the above-obtained polymerization catalyst was used so as to obtain a copolymer having a density and MFR shown in Table 1. The properties of the ethylene/α-olefin copolymer (A-5) are set forth in Table 1.

### Example 5

The ethylene/α-olefin copolymer obtained in Preparation Example 5 was injection molded in the same manner as in Example 1 to prepare a specimen for property measurement, and the properties of the specimen were measured.

The results are set forth in Table 2.

### Preparation Example 6

A copolymer (A-6) was prepared using a carrier-supported type catalyst comprising anhydrous magnesium chloride and titanium tetrachloride.

The resulting ethylene/α-olefin copolymer (A-6) had a density of 0.923 g/cm³, a melt flow rate of 3.5 g/10 min, a decane-soluble component fraction (at 23° C.) of 2.6% by weight, Mw/Mn of 4.77 and Tm of 122.5° C.

### Comparative Example 1

The ethylene/α-olefin copolymer (A-6) obtained in Preparation Example 6 was injection molded in the same manner as in Example 1 to prepare a specimen for property measurement, and the properties of the specimen were measured.

The results are set forth in Table 2.

### Preparation Example 7

Preparation of catalyst

An ethylene/α-olefin copolymer (A-7) was obtained in the same manner as in Preparation Example 1, except that ethylenebis(indenyl)zirconium dichloride was used instead of the bis(1,3-n-butylmethylcyclopentadienyl)zirconium dichloride and 1-butene was used as a comonomer. The properties of the ethylene/α-olefin copolymer (A-7) are set forth in Table 1.

### Example 6

The ethylene/α-olefin copolymer (A-7) obtained in Preparation Example 7 was injection molded in the same manner as in Example 1 to prepare a specimen for property measurement, and the properties of the specimen were measured.

The results are set forth in Table 2.

### Preparation Example 8

An ethylene/α-olefin copolymer (A-8) was obtained in the same manner as in Preparation Example 7, except that the reaction conditions were controlled so as to obtain a copolymer having a density and MFR shown in Table 1. The properties of the ethylene/α-olefin copolymer (A-8) are set forth in Table 1.

### Example 7

The ethylene/α-olefin copolymer (A-8) obtained in Preparation Example 8 was injection molded in the same manner as in Example 1 to prepare a specimen for property measurement, and the properties of the specimen were measured.

The results are set forth in Table 2.

### Preparation Example 9

Ethylene/α-olefin copolymers (A-9) and (A-10) were each obtained in the same manner as in Preparation Example 7, except that the reaction conditions were controlled so as to obtain a copolymer having a density and MFR shown in Table 1. The properties of the ethylene/α-olefin copolymer (A-9) are set forth in Table 1.

### Example 8

The ethylene/α-olefin copolymer (A-9) obtained in Preparation Example 9 was injection molded in the same manner as in Example 1 to prepare a specimen for property measurement, and the properties of the specimen were measured.

The results are set forth in Table 2.

### Comparative Example 2

Mirason 16 (A-11) (available from Mitsui Dupont Polychemical Co.) having properties shown in Table 1 was injection molded in the same manner as in Example 1 to prepare a specimen for property measurement, and the properties of the specimen were measured.

The results are set forth in Table 2.

TABLE 1

| | | Comonomer | | MFR | Dens- | n-decane | | | | | | | |
|---|---|---|---|---|---|---|---|---|---|---|---|---|---|
| | | | Content | g/10 | ity | soluble | | | TM | | MT | | |
| | | Type | mol % | min | g/cm³ | part wt % | *1 | *2 | ° C. | *3 | g | *4 | Mw/Mn |
| Prep. | A-1 | 1- | 3.2 | 18.5 | 0.919 | 0.58 | 3.00 | | 114.5 | 117.6 | | | |
| Ex. 1 | | hexene | | | | | | | | | | | |
| Prep. | A-2 | 1- | 3.2 | 19.3 | 0.920 | 0.53 | 2.79 | | 114.8 | 118.0 | | | |
| Ex. 2 | | hexene | | | | | | | | | | | |
| Prep. | A-3 | 1- | 2.1 | 15.0 | 0.930 | 0.33 | 0.96 | | 120.6 | 122.0 | | | |
| Ex. 3 | | hexene | | | | | | | | | | | |
| Prep. | A-4 | 1- | 3.9 | 14.2 | 0.915 | 0.67 | 3.81 | | 114.0 | 116.0 | | | |
| Ex. 4 | | hexene | | | | | | | | | | | |
| Prep. | A-5 | 1- | 3.2 | 18.8 | 0.919 | 0.61 | 3.03 | | 114.4 | 117.6 | | | |
| Ex. 5 | | hexene | | | | | | | | | | | |
| Prep. | A-6 | 1- | 5.0 | 20.0 | 0.920 | 8.96 | 2.83 | | 122.6 | 118.0 | | | |
| Ex. 6 | | hexene | | | | | | | | | | | |
| Prep. | A-7 | 1- | 2.7 | 3.5 | 0.923 | 0.26 | | 1.19 | 112.4 | | 3.3 | 1.8 | 4.77 |
| Ex. 7 | | butene | | | | | | | | | | | |
| Prep. | A-8 | 1- | 2.6 | 4.0 | 0.924 | 0.22 | | 1.08 | 112.5 | | 3.0 | 1.6 | 4.85 |
| Ex. 8 | | butene | | | | | | | | | | | |
| Prep. | A-9 | 1- | 2.1 | 3.0 | 0.930 | 0.20 | | 0.64 | 115.5 | | 3.9 | 2.0 | 5.02 |
| Ex. 9 | | butene | | | | | | | | | | | |
| Prep. | A-10 | 1- | 2.8 | 3.8 | 0.922 | 0.21 | | 1.30 | 114.2 | | 0.4 | 1.7 | 2.06 |
| Ex. 10 | | butene | | | | | | | | | | | |

| | | | | | | | | | |
|---|---|---|---|---|---|---|---|---|---|
| A-11 | High-pressure | 3.6 | 0.924 | — | — | 109.6 | 6.3 | — | 7.24 |
| | polyethylene | | | | | | | | |

*1 Value of 80 × (MFR − 9)^{8.26} × exp(−100(d − 0.88) + 0.1
*2 Value of 80 × exp(−100(d − 0.88) + 0.1
*3 Value of 400 × d − 250
*4 Value of 4.0 × MFR^{-8.65}

TABLE 2

| | | Elastic | | | ESCR | Izod low- |
|---|---|---|---|---|---|---|
| | | modu- | Strength | Elongation | proper- | temperature |
| | Co- | lus | at break | at break | ties | impact |
| | polymer | (MPa) | (MPa) | (%) | F₅₀ (hr) | (J/m) |
| Ex. 1 | A-1 | 210 | 28 | | >600 | Not broken |
| Ex. 2 | A-2 | 230 | 27 | | >600 | Not broken |
| Ex. 3 | A-3 | 260 | 23 | | 250 | Not broken |
| Ex. 4 | A-4 | 170 | 33 | | >600 | Not broken |
| Ex. 5 | A-5 | 210 | 26 | | >600 | Not broken |
| Comp. | A-6 | 230 | 21 | | 200 | Not broken |
| Ex. 1 | | | | | | |
| Ex.6 | A-7 | 240 | 15 | 510 | 120 | |
| Ex.7 | A-8 | 240 | 15 | 520 | 120 | |
| Ex.8 | A-9 | 340 | 13 | 490 | 80 | |
| Comp. | A-11 | 240 | 15 | 460 | 10 | |
| Ex.2 | | | | | | |

What is claimed is:

1. An ethylene resin injection molded article obtained by injection molding an ethylene/α-olefin copolymer (A) which is a copolymer of ethylene and an α-olefin of 3 to 12 carbon atoms and has the following properties:
(i) the density is in the range of 0.880 to 0.940 g/cm³,
(ii) the melt flow rate (MFR) at 190° C. under a load of 2.16 kg is in the range of 1 to 100 g/10 min,
(iii) the decane-soluble component fraction (W (% by weight)) at room temperature and the density (d (g/cm³)) satisfy the following relation
in case of MFR <10 g/l1 min:
W<80×exp(−100(d-0.88))+0.1,
in case of MRF>10 g/l min:
W<80×(MFR-9)^{0.26}×exp(−100(d-0.88))+0.1, and
(iv) the temperature (Tm (°C.)) at the maximum peak position in the endothermic curve as measured by a differential scanning calorimeter (DSC) and the density (d (g/cm³)) satisfy the following relation
Tm<400×d-250.

2. The ethylene resin injection molded article as claimed in claim 1, wherein the ethylene/α-olefin copolymer (A) comprises a copolymer obtained by copolymerizing ethylene and an α-olefin of 3 to 12 carbon atoms in the presence of an olefin polymerization catalyst comprising:
(a) a compound of a transition metal of Group IV of the periodic table, which contains a substituted cyclopentadienyl group as a ligand, and
(b) an organoaluminum oxy-compound.

3. An ethylene resin injection molded article obtained by injection molding an ethylene/α-olefin copolymer (B) which is a copolymer of ethylene and an α-olefin of 3 to 12 carbon atoms and has the following properties:
(i) the density is in the range of 0.880 to 0.940 g/cm³,
(ii) the melt flow rate (MFR) at 190° C. under a load of 2.16 kg is in the range of 1 to 100 g/10 min,
(iii) the decane-soluble component fraction (W (% by weight)) at room temperature and the density (d (g/cm³)) satisfy the following relation
in case of MFR<10 g/10 min:
W<80×exp(−100(d-0.88))+0.1,
in case of MFR>10 g/10 min:
W<80×(MFR-9)^{0.26}×exp(−100(d-0.88))+0.1,
(iv) the temperature (Tm (°C.)) at the maximum peak position in the endothermic curve as measured by a differential scanning calorimeter (DSC) and the density (d (g/cm³)) satisfy the following relation
Tm<400×d-250,
(v) the molecular weight distribution (Mw/Mn, Mw: weight-average molecular weight, Mn: number-average molecular weight) as measured by gel permeation chromatography (GPC) is in the range of 3 to 7, and
(vi) the melt tension (MT) at 190° C. and the melt flow rate (MFR) satisfy the following relation
MT>4.0×MFR-^{0.65}.

4. The ethylene resin injection molded article as claimed in claim 3, wherein the ethylene/α-olefin copolymer (B) comprises a copolymer obtained by copolymerizing ethylene and an α-olefin of 3 to 12 carbon atoms in the presence of an olefin polymerization catalyst comprising:
(a) a compound of a transition metal of Group IV of the periodic table, which contains a bidentate ligand wherein two groups selected from indenyl groups and substituted indenyl groups are linked through a lower alkylene group, and
(b) an organoaluminum oxy-compound.

5. The ethylene resin injection molded article as claimed in any one of claims 1 to 4, wherein when the ethylene/α-olefin copolymer (A) or (B) is subjected to a temperature rise elution test (TREF), a component that is eluted at a temperature of not lower than 100° C. is present in the copolymer and the amount of said component is not more than 10% of the whole elution amount.
